(19) United States
(12) Patent Application Publication
(10) Pub. No.: US 2025/0027643 A1
(43) Pub. Date: Jan. 23, 2025

(54) HEATER WITH REMOTE COMBUSTION AIR ADDITION

(71) Applicant: Lummus Technology LLC, Bloomfield, NJ (US)

(72) Inventors: Baozhong ZHAO, Livingston, NJ (US); Marinus Adriaan POLS, Morristown, NJ (US); Daniel MCKENZIE, West Orange, NJ (US)

(21) Appl. No.: 18/775,343

(22) Filed: Jul. 17, 2024

Related U.S. Application Data
(60) Provisional application No. 63/514,248, filed on Jul. 18, 2023.

(51) Int. Cl. F23C 6/04; F23C 3/00; F23L 9/04

(52) U.S. Cl. CPC F23C 6/045; F23C 3/002; F23L 9/04; F23C 2900/9901; F23L 2900/15043

(57) ABSTRACT

A heater includes a radiant section with a bottom wall and a side wall. A burner is provided on the bottom wall and a primary fuel stream and a primary combustion air stream are provided through the burner to support a primary combustion reaction local to the burner. The primary combustion air stream may be less than the air needed to burn all of the primary fuel stream, resulting in the primary combustion reaction being sub-stochiometric and reducing NOx formation. A remote air pipe injects remote air into the radiant section distal to the burner, and in some cases, spaced from the burner by at least two meters. The remote air addition supports a lean secondary combustion reaction that further minimizes NOx emissions concentration. The heater is suitable for use with high H2 fuel or preheated air, or both, to lower CO2 emissions while meeting NOx emission targets.

### BACKGROUND

### Technical Field

The present disclosure generally relates to a heater, and more particularly, but not exclusively, relates to a heater with remote combustion air addition for lowering nitrogen oxides (“NOx”) emissions and for maintaining or reducing the NOx emission to the heater with low carbon dioxide emission.

### Description of the Related Art

Heaters for use in petrochemical processing applications are known and include fired heaters that burn or fire fossil fuels to generate heat for processing applications. Existing fired heaters produce CO2 and NOx emissions as a result of firing such fossil fuels. Typical NOx emissions include nitric oxide (“NO”) and nitrogen dioxide (“NO2”) which are collectively referred to herein as NOx emissions. The emissions from fired heaters, namely CO2 and NOx, are concerning in view of their effects on climate change and the environment, and more recently, CO2 and NOx emissions have been subject to regulations limiting permissible amounts of these emissions. As a result, solutions have been proposed to limit CO2 and NOx emissions from fired heaters, although these solutions have several deficiencies and drawbacks.

The resulting CO2 and NOx emissions from firing fossil fuels depends on several factors, including at least the temperature of the air provided for combustion, the fuel for combustion, the amount of air and/or oxygen available for combustion, the location of introduction of the fuel and/or the air for the combustion reaction, the flame temperature, the ratio of fuel and air at the location of combustion, and others.

One solution to minimize CO2 emissions is to drive the fired heater to have a minimum amount of fuel firing and maximum heat recovery. In such an example, the combustion air may be preheated, or the fuel may be rich in hydrogen (“H2”) to minimize fuel firing and CO2 emissions. For the air preheat option, the combustion air will be preheated in an air preheater against either the combustion flue gas or a hot stream from other sources. Firing with preheated air reduces the fuel but will result in higher NOx emission due to higher flame temperature. For the fuel rich in H2 option, CO2 emissions are lowered by firing high H2 fuel or full H2 fuel. The H2 fuel does not generate any CO2. However, the flame temperature with high H2 fuel is high, and the high flame temperature leads to higher NOx emission.

On the other hand, NOx emissions are typically controlled in three ways in existing technology. The first method is to use so-called pre-combustion technology, such as “oxy-fuel technology” where combustion air for the burning of fossil fuels includes high oxygen or full oxygen content. This method of high oxygen content firing combines with other technology to reduce NOx emission or eliminates nitrogen in the combustion air, and as a result, eliminates NOx emissions. The second method is to rely on combustion technology. For example, the burner is fired with ambient air, preheated ambient air, or gas turbine exhaust. These techniques may also be referred to as staged fuel burners or staged air burners that are described further herein. With stage fuel burners or staged air burners, the combustion intensity can be reduced, which helps to lower the flame temperature, thereby leading to lower NOx emissions. The third method is to use post-combustion technology. In this method, the NOx content in the combustion exhaust gas following firing of the fossil fuels is reduced by a selective catalytic reduction (“SCR”) unit in the convection section. The SCR unit utilizes a catalyst that initiates a chemical reaction to convert NOx into nitrogen and water, thereby reducing NOx emissions. However, CO2 emissions can remain a concern with the above methods for addressing NOx emissions.

Further methods to lower NOx emissions are focused on burner designs. Conventional burners are designed to have a proper ratio between the fuel and combustion air at each burner. Either the fuel is injected through the primary tips and staged tips, or the combustion air is introduced through the burner tile targeting different locations near the vicinity of the burner to lower the NOx emission.

As one example of such a burner arrangement, U.S. Pat. No. 7,172,412 to Platvoet et al. appears to disclose a wall stabilizer tip (“WST”) in the heater that may be installed at about 4m above the hearth burners. The WST uses fuel injection only and does not have any combustion air addition, except a small amount of cooling air to keep the tip below the temperature of the material use limits. Under normal operating conditions, the hearth burner will be fired with high excess air. The excess air, which is more than required for the fuel from the hearth burner, will react with the fuel from the WST. Thus, the WST is a remote fuel injection to the hearth burner and its main purposes are to ensure the hearth burner flame remains attached to the wall, off load the hearth burner heat release, and improve the heat flux distribution at the upper section of the radiant box. It is not intended for lower NOx and has limited impact on the NOx reduction. Further, it may have concerns with CO emissions.

In a further example of a burner arrangement, U.S. Pat. No. 7,025,590 to Bussman et al. appears to describe a burner arrangement of hearth burners, wall burners, and remote fuel staging (“RFS”) tips. The hearth burners are typically designed to allow about 10% excess air. Some of the wall burners may be designed with 10% excess air and some with more than 10% excess air. The RFS tips will have fuel flow only without any combustion air. The air through the wall burners will support the fuel combustion from the RFS tips. The RFS tips are designed to lower the NOx in combination with burners having premix features. However, the burner arrangement described in this reference has difficulties in firing certain types of fuel, such as high H2 fuel and firing with hot combustion air. As a result, this solution has issues with at least CO2 emissions.

The above solutions for limiting CO2 emissions are not necessarily compatible with technologies for limiting NOx emissions. As a result, existing solutions typically address either CO2 emissions or NOx emissions, but not both, and are therefore incomplete solutions at best.

In view of the above, it would be advantageous to have heater devices, systems, and methods that overcome the deficiencies and disadvantages of known solutions.

### BRIEF SUMMARY

The present disclosure is generally directed to heater devices, systems, and methods for lowering CO2 and NOx emissions. In particular, but not exclusively, the disclosure contemplates techniques that are particularly advantageous for fired heaters, either new or existing, with preheated combustion air and/or for firing high H2 fuels. In conventional applications, preheated combustion air can lead to higher NOx emissions, while firing high H2 fuel lowers CO2 emissions. However, the concepts of the disclosure utilize remote combustion air addition, which as described further below, lowers NOx emissions while also being suitable for high H2 fuel applications, thereby lowering CO2 emissions. Thus, the concepts of the disclosure enable air preheat combustion and high H2 firing with comparatively low overall CO2 and NOx emissions relative to existing techniques.

The present disclosure contemplates applying remote air addition or injection, instead of remote fuel injection as in prior solutions, to create a low-intensity primary combustion in a reducing environment and a secondary diluted combustion zone away from the burners. The low-intensity primary combustion zone will have fuel rich or sub-stoichiometric combustion that minimizes NOx formation and the secondary diffused combustion reaction will create very lean combustion that further lowers NOx emissions concentration. Further, the above techniques are suitable for high H2 fuel, thereby lowering CO2 emissions.

In an implementation, a heater has hearth burners corresponding to a primary combustion zone or primary zone. All of the fuel for combustion will be released through the hearth burner or multiple hearth burners. Combustion air through the hearth burner will be for a fraction of the fuel through the burner (i.e., the hearth burner will be fired under sub-stoichiometric condition or fuel-rich combustion). Such an arrangement will create a reducing environment for the fuel combustion, which will reduce NOx formation. The residual unburned fuel will move up with the combustion exhaust from the primary zone to a secondary combustion zone or secondary zone that is spaced from the primary combustion zone. At the secondary zone, a stream of combustion air will be remotely introduced to the heater above the hearth burner. The air introduction may be through one connection or multiple connections at the same elevation or different elevations. The unburned fuel will react with oxygen in the remote combustion air by diffusing into the air stream and result in diffused or diluted combustion that further minimizes NOx concentration. Compared with conventional burner design with staged fuel or stage air, this firing arrangement will result in overall lower NOx emission while being suitable for high H2 fuel, thereby lowering CO2 emissions.

Other features and advantages of the concepts of the disclosure are provided below.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The figures do not describe every aspect of the teachings disclosed herein and do not limit the scope of the claims.

FIG. 1A and FIG. 1B are schematic illustrations of a staged fuel burner and a staged air burner, respectively, provided to illustrate the benefits of the techniques of the disclosure.

FIG. 2 is a schematic illustration of an implementation of a heater with remote combustion air addition according to the techniques of the present disclosure.

FIG. 3A, FIG. 3B, and FIG. 3C are schematic illustrations of the heater of FIG. 2 with different configurations for introducing the remote combustion air into a radiant box of the heater.

FIG. 4A, FIG. 4B, and FIG. 4C are schematic illustrations of the heaters of FIG. 3A, FIG. 3B, and FIG. 3C, respectively, with a wall burner associated with the different configurations for introducing the remote combustion air.

FIG. 5 is a schematic illustration of the heater of FIG. 2 with a catalyst bed.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide heater devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

The present disclosure is generally directed to heaters with remote air addition to create a low-intensity primary combustion zone in a reducing environment and a secondary diluted combustion zone away from the burners associated with the primary combustion zone. Such an arrangement is suitable for high H2 fuel applications, thereby reducing CO2 emissions, while operating the primary combustion zone in a reducing environment lowers NOx emissions. The techniques disclosed here are useful for reducing the NOx emissions from new and existing fired heaters. In particular, it becomes possible for heaters to adopt low CO2 technologies within the NOx emission limits without the addition of SCR. The elimination of SCR eliminates significant associated maintenance costs and downtime with maintaining SCR units over time, among other benefits.

Unless the context clearly dictates otherwise, the term “remote” when used herein to describe the introduction of air, such as “remote air addition” means air that is injected into a heater several meters away from the primary burners that support the primary combustion zone, such as two meters, three meters, or four meters or more from the primary burners to support a secondary combustion zone that is separate and distinct from the primary combustion zone. “Remote” air addition can be distinguished from the concepts of staged air, where air is injected at or near (i.e., less than one meter) from the primary burners to support the primary combustion zone and is not associated with a secondary combustion zone. Thus, “remote” air addition is also consistent with air injection at a location that is outside the primary combustion zone.

Unless the context clearly dictates otherwise, the phrase “combustion zone” refers to a location in a heater where a combustion reaction takes place and specifically refers to the portion of the heater occupied by the flame envelope or the flameless combustion envelope of such combustion reaction. As a result, “remote” air addition may also refer to injecting air at a location that is outside the flame envelope or the flameless combustion envelope of an indicated combustion zone.

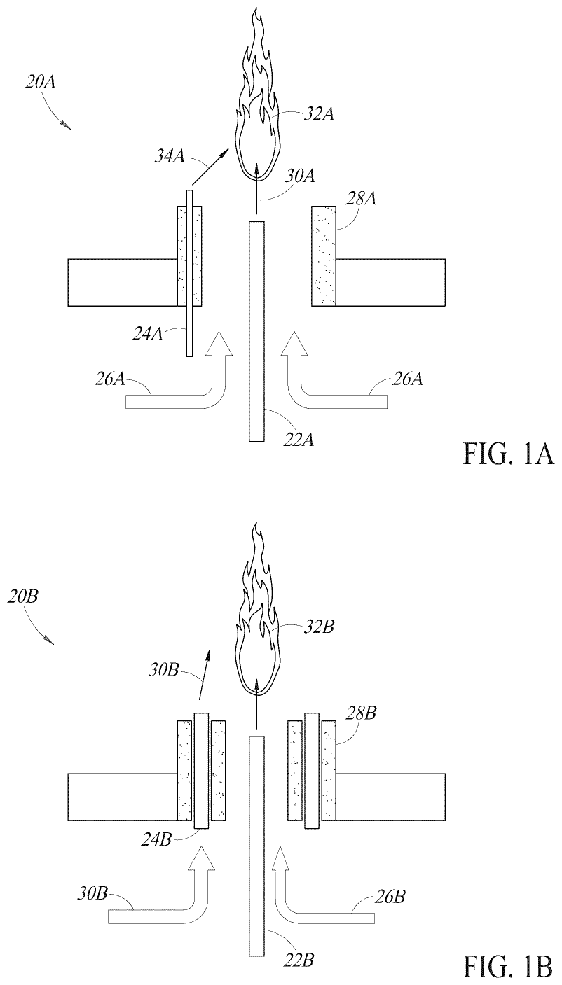

FIG. 1A and FIG. 1B are schematic illustrations of a staged fuel burner 20A and a staged air burner 20B, respectively, provided to illustrate the benefits of the techniques of the disclosure. Beginning with FIG. 1A, the staged fuel burner 20A may include a primary fuel conduit 22A and a staged fuel conduit 24A. Combustion air, indicated by arrows 26A, is introduced in a space between the primary fuel conduit 22A and walls 28A of the burner 20A. The staged fuel conduit 24A may extend through one of the walls 28A of the burner 20A. In operation, the primary fuel conduit 22A outputs the primary fuel for the combustion reaction, as shown by arrow 30A. The primary fuel 30A reacts with the combustion air 26A when a sufficient operating temperature is reached to generate a combustion reaction represented schematically by flame 32A. The flame 32A also represents a primary combustion zone proximate or at the staged fuel burner 20A. The staged fuel conduit 24A outputs staged fuel represented by arrow 34A.

Turning to FIG. 1B, the staged air burner 20B is similar to the staged fuel burner 20A, except staged air is introduced to the primary combustion zone instead of staged fuel. More specifically, the staged air burner 20B includes a fuel conduit 22B and a staged air conduit 24B. Primary combustion air, represented by arrow 26B, is introduced in the space between the fuel conduit 22B and walls 28B of the burner 20B. Staged air, represented by arrow 30B is introduced via the staged air conduit 24B. The fuel from fuel conduit 22B reacts with the primary air 26B and staged air 30B to produce a combustion reaction 32B, as described above.

In both examples above, the staged fuel 34A and the staged air 30B are utilized to vary the characteristics of the combustion reaction. For example, amount of staged fuel 34A and/or staged air 30B that is introduced into the primary combustion zone may change the combustion intensity, such as to lower the combustion intensity. Lowering the combustion intensity helps to lower the flame temperature, thereby reducing NOx emissions. However, these techniques also have drawbacks as well. For example, when remote fuel or air burners are combined with remote fuel injection, the remote fuel injection has no impact on further reducing NOx emissions concentration. Staged fuel and staged air burners also have limitations, in particular with preheated air or high H2 fuel applications. In such examples, the preheated air and/or high H2 fuel increases NOx emissions, which, in turn, cannot be limited by the burners 20A, 20B and may, in some cases, exceed acceptable emissions limits.

In contrast, the concepts of the disclosure apply remote air addition or injection, instead of remote fuel injection, to create a low intensity primary combustion in a reducing environment and a secondary diluted combustion zone away from the burners. The low-intensity primary combustion zone will have fuel rich or sub-stoichiometric combustion that minimizes NOx formation and the secondary diffused combustion will create very lean combustion that lowers, reduces, or minimizes NOx. The concepts of the disclosure are also suitable for preheated air and/or high H2 fuel applications because the reduction in NOx resulting from the lean secondary combustion zone allows for reduction in overall NOx emissions to below acceptable emissions standards, even with preheated air and/or high H2 fuel. With both staged fuel and staged air burners, such as burners 20A, 20B, respectively, the introduction of fuel and air is local to the burners 20A, 20B such that the benefits described herein are not achievable with these conventional burner technologies.

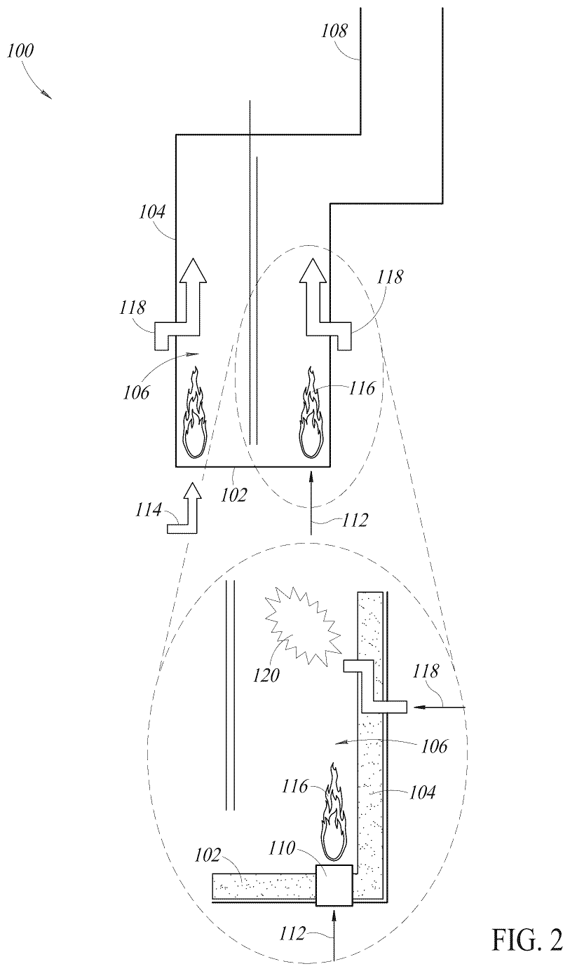

FIG. 2 is a schematic illustration of an implementation of a heater 100 with remote combustion air addition according to the techniques of the present disclosure. Although the following disclosure is based on the heater 100 being a cracking heater for the production of ethylene, it is to be appreciated that such example is non-limiting and the techniques of the disclosure can be applied equally to other heaters and/or other process heaters. The heater 100 includes a bottom wall 102 coupled to sidewalls 104 that collectively define a radiant section 106 and an exhaust section 108. The heater 100 further includes at least one burner 110, which may be a hearth burner, located on the bottom wall 102. The at least one burner 110 may generally include a selected number and arrangement of burners 110. In an implementation, all of the burners 110 are arranged on the bottom wall 102 of the heater 100. All of the fuel, represented by arrow 112, is introduced to the radiant section 104 through the burner 110 or through multiple burners 110.

Combustion air through the burner 110, represented by arrow 114, will be for a fraction of the fuel through the burner 110. In a non-limiting example, the combustion air introduced through the burner 110 (or burners 110) is for approximately 60%-70% of the fuel 112 introduced through the burner 110 (or burners 110) and thus the combustion air 114 may also be referred to as major or primary combustion air 114. Once the radiant section 104 reaches reaction temperature, the fuel 112 and the primary combustion air 114 are fired under sub-stoichiometric condition or fuel-rich combustion, represented by schematic flame 116. The fuel-rich combustion condition is a result of all of the fuel 112 being introduced at the burner 110 with a fraction of the combustion air needed to fully burn such fuel, or primary combustion air 114. Such an arrangement creates a reducing environment for the fuel combustion which will reduce NOx formation.

The residual unburned fuel will move up the radiant section with the combustion exhaust toward exhaust 108 of the heater 100 according to the ordinary meaning of “up” as toward a higher place or position, or the opposite direction of down in the sense that gravity pulls object down. A stream of combustion air will be remotely introduced to the heater 100 above the burner 110, as represented by arrows 118. The combustion air 118 may be the remote combustion air 118 or secondary combustion air 118 discussed herein. The remote combustion air 118 introduction may be through one connection or multiple connections each at the same elevation or different elevations along the sidewalls 104 relative to the bottom wall 102. As shown in FIG. 2, the remote combustion air 118 is remote in the sense that it is introduced at a location that is multiple meters away (and vertically upward along the sidewalls 104) from the burners 110 and outside of the primary combustion zone associated with the burner 110 that is represented by flame 116. The unburned fuel from the primary combustion zone 116 will react with the oxygen in the remote combustion air 118 by diffusing into the air stream and result in a secondary diffused or diluted combustion zone 120. Following the non-limiting example above, the remote combustion air 118 may preferably be approximately 40%-50% or higher of the total combustion air for all of the fuel provided through the burner 110, including excess air. Thus, the remote combustion air 118 may be a minor or secondary combustion air stream. The lean combustion reaction produced at the secondary combustion zone 120 further lowers NOx emissions concentration.

Compared with conventional burner design with staged fuel or stage air, such as with burners 20A, 20B, respectively, the techniques described with reference to FIG. 2 will result in overall lower NOx emission as a result of the fuel-rich primary combustion zone 116 that minimizes NOx formation and the lean, diluted secondary combustion zone 120 associated with the remote air addition 118 that further lowers NOx emissions concentration. Given the overall reduction in NOx emissions by the techniques discussed above, the technology is suitable for use with preheated air and/or high H2 fuel, thereby enabling a reduction in CO2 emissions while maintaining NOx emissions within acceptable levels despite preheated air and/or high H2 fuel generally increasing NOx emissions.

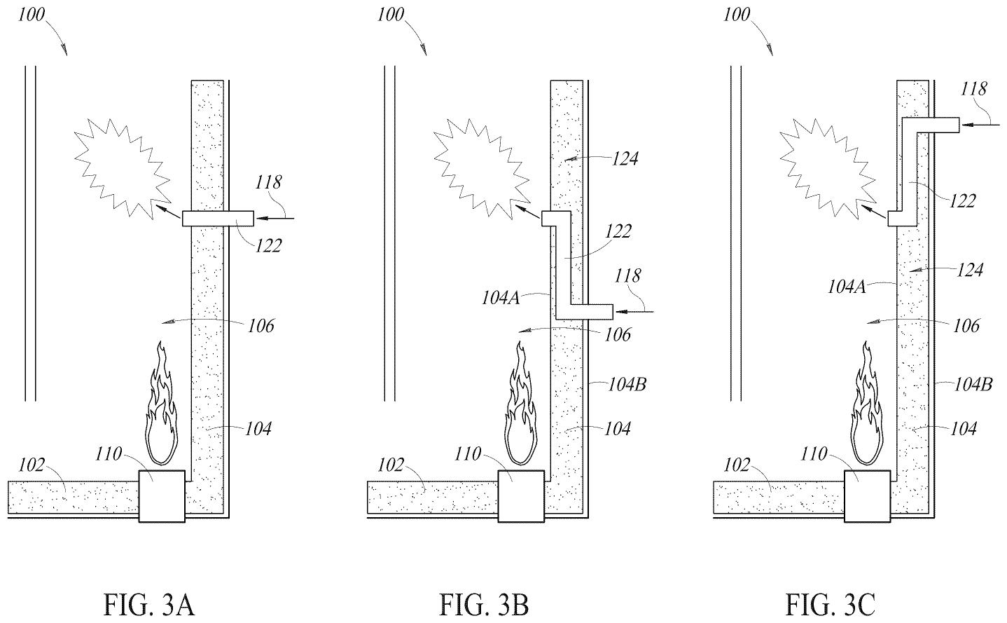

FIGS. 3A-3C are schematic illustrations of the heater 100 with different configurations for introducing the remote combustion air 118 into the radiant section 106 of the heater 100. As mentioned above, the remote combustion air 118 may be introduced into the radiant section 106 at a location along the sidewalls 104 of the heater 100 that is “remote” from the burner 110 located on the bottom wall 102 of the heater 100 as “remote” is defined herein. The remote combustion air 118 may be introduced via a remote air pipe 122 that extends through the sidewall 104 of the heater 100. The remote air pipe 122 may be ducts or piping for conveying the remote combustion air 118. As shown in FIGS. 3A-3C, the remote air pipe 122 can have different configurations.

For example, with reference to FIG. 3A, the remote air pipe 122 can extend directly through the sidewall 104 of the heater 100 without a substantial change in direction (i.e., a change in direction of less than 5 degrees). In such an arrangement, the remote combustion air 118 would not be appreciably pre-heated by the heat in the sidewall 104, but would have a shorter length, thereby reducing costs. In FIG. 3B, the remote air pipe 122 enters the sidewall 104 and traverses upward through the sidewall 104 according to the definition of “up” provided above before injecting the remote combustion air 118 into the radiant section 106 at a higher elevation relative to the sidewall 104 than the location where the remote air pipe 122 first enters the sidewall 104. In FIG. 3B, the remote air pipe 122 enters the sidewall 104 and traverses downward through the sidewall 104 according to the definition of “down” as gravity pulls objects down, before injecting the remote combustion air 118 into the radiant section 106 at a lower elevation relative to the sidewall 104 than the location where the remote air pipe 122 first enters the sidewall 104.

The heater 100 may have an empty space 124 between inner and outer sidewalls 104A, 104B. In FIG. 3B and FIG. 3C, this empty space 124 is utilized to run the remote air pipe 122 along and through the sidewall 104. Such an arrangement provides preheating of the remote combustion air 118 in the remote air pipe 122 via the heat duty from the ongoing combustion reaction(s) in the radiant section 106. The remote air pipes 122 of FIG. 3B and FIG. 3C may be located at a selected elevation along the sidewall 104 and/or the inner and outer sidewalls 104A, 104B, which will help to lower the peak flame temperature by absorbing the heat from the flame. Alternatively, the remote air pipes 122 may be located at an elevation where the maximum peak heat flux or maximum tube metal temperature (“TMT”) may occur. The preheating of the remote combustion air 118 will lower the wall hot face surface temperature, which, in turn, will reduce the radiation to reduce the TMT and enable use of more cost-effective materials with a lower acceptable TMT.

In a preferred implementation, the primary combustion air 114 provided through the burner 110 (or burners 110) is no more than 70% of the combustion air for the amount of fuel through the burner 110, even though the amount of air through the burner 110 can be higher or lower within a safe margin to maintain the flame stability. The optimum air split between the primary combustion air 114 flow through the burner 110 and the remote combustion air 118 flow depends upon the NOx emission limits and the fuel compositions.

The primary combustion air 114 through the burner 110 can be ambient air, preheated air, or an exhaust containing oxygen from other streams, such as gas turbine exhaust. The remote combustion air 118 can also be ambient air, preheated air, or an exhaust stream with valuable oxygen for combustion. The remote combustion air 118 can be from the same source for the burner 110 (or burners 110) or independent of the source for the burner 110.

In a further implementation, the total amount of combustion air 114, 118 (i.e., a combination of primary combustion air 114 and remote combustion air 118) to the heater 100 may be 10% or higher than the amount needed for the total amount of fuel 112 through the burner 110 (or burners 110). This results in higher excess air to ensure complete combustion inside the radiant section 106, and/or sufficient amount of flue gas through the convection for proper heat distribution to various streams in the convection section, and/or less excess air to minimize heat loss through the heater stack.

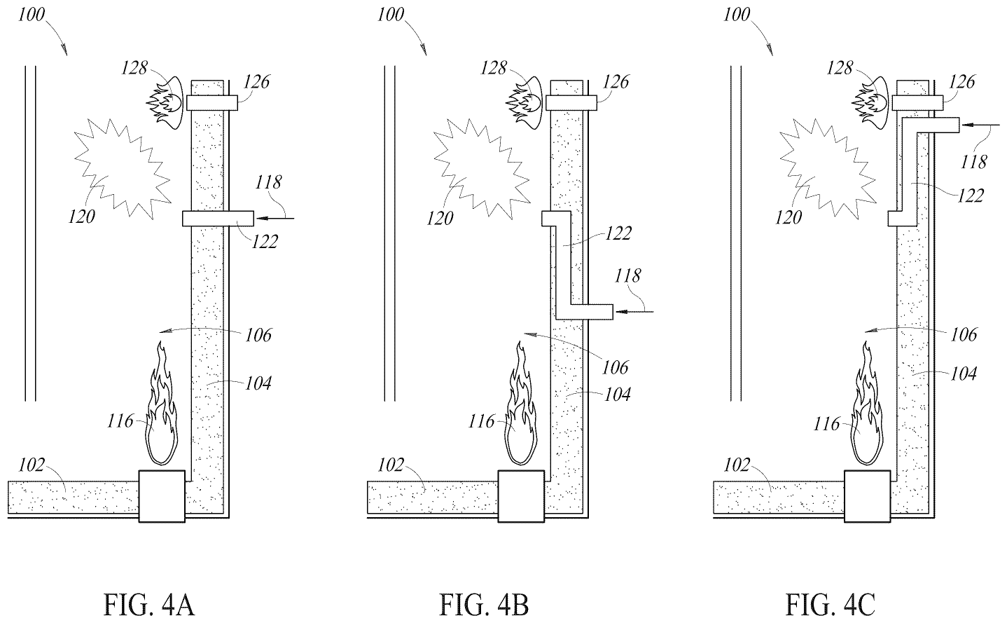

FIG. 4A, FIG. 4B, and FIG. 4C are schematic illustrations of the heaters 100 of FIG. 3A, FIG. 3B, and FIG. 3C, respectively, with a wall burner 126 associated with the different configurations for introducing the remote combustion air 118. In some situations, not all of the combustibles from the primary fuel 114 (FIG. 1) will be consumed following the primary combustion zone 116 and the secondary or remote combustion zone 120. Thus, the heater 100 may also include one row of wall burners 126 to consume any remaining unburned hydrocarbon following the primary and secondary combustion zones 116, 120. The wall burners 126 are preferably only one row of burners 126, although other options and configurations, such as multiple rows are contemplated herein. As shown in FIG. 4A-4C, the wall burners 126 are located on the sidewall 104 above the location of introduction of the remote combustion air 118 into the radiant section 106 (i.e., above an outlet of the remote air pipes 122 into the radiant section 106) relative to the bottom wall 102 of the heater 100. The use of “above” in this context is similar to the definition of “up” provided herein. In an implementation, the wall burners 126 are located at the same position or elevation relative to the bottom wall 102 regardless of the location of the outlet of the remote air pipes 122 into the radiant section. Alternatively, because the location or elevation of the outlet of the remote air pipes 122 relative to the bottom wall 102 may vary depending on the configuration of the remote air pipes 122, the location or elevation of the wall burners 126 may likewise vary to provide constant spacing relative to the outlet of the remote air pipes 122 in some implementations.

When the heater 100 reaches reaction temperature, the wall burners 126 are associated with a third or tertiary combustion zone represented by schematic flame 128. The third combustion zone 126 maybe outside of, and spaced above, the envelope of the second combustion zone 120 associated with the remote air addition 118. The third combustion zone 128 consumes any remaining combustibles in the primary fuel 114 (FIG. 1) to avoid the same being provided to exhaust 108 (FIG. 1). In some implementations, the third combustion zone 128 may be below the location of introduction of the remote air 118 into the radiant section, although the same may be less preferred. The wall burners 126 allow for adjustment of the heat flux and, at the same time, ensure all combustibles will be burned prior to entering the convection section and/or exhaust 108 (FIG. 1). In an implementation where the heater 100 is an ethylene cracking heater, the reaction temperature may be at least 700 degrees Celsius (“C”), and more preferably about 850 degrees C. to 950 degrees C. for maximum yields. Thus, at the reaction temperature, the primary fuel stream 112 spontaneously combusts without a separate ignition element when the conditions for a combustion reaction are present, such as sufficient oxygen and/or air provided by the air streams described herein.

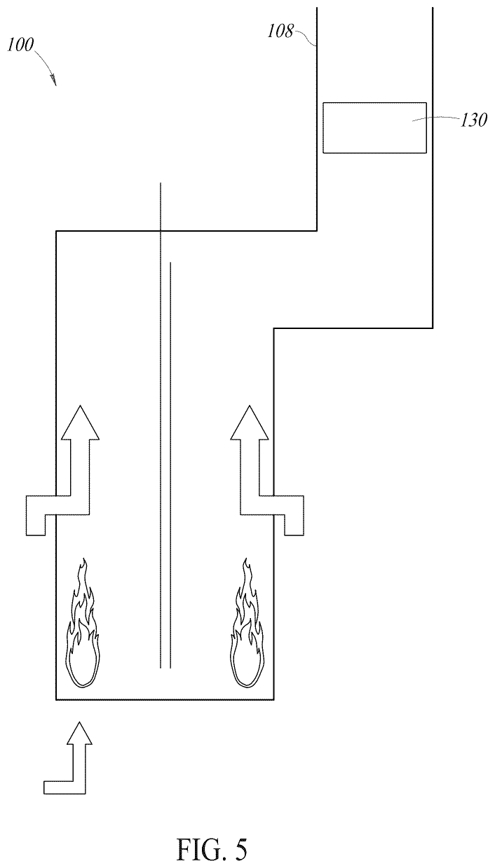

FIG. 5 is a schematic illustration of the heater 100 of FIG. 2 with a catalyst bed 130. One potential issue with the heater 100, depending on the factors discussed above regarding emissions, is the potential for carbon monoxide (“CO”) emissions. Thus, the present disclosure also contemplates including the catalyst bed 130 in exhaust 108 of the heater 100 to reduce CO emissions. The catalyst bed 130 relies only on a catalyst to reduce CO emissions, rather than a catalyst and ammonia injection for SCR for NOx emissions. As a result, the catalyst bed 130 has lower operation costs than SCR and also eliminates the need for alternatives to SCR, such as ammonia flow control units (“AFCU”) and/or ammonia injection grids (“AIG”) that likewise have higher operation cost for controlling NOx emissions. In a preferred implementation, the catalyst bed 130 is not needed to achieve acceptable emissions and otherwise provide the advantages discussed herein with respect to the heater 100. However, the catalyst bed 130 can be included to further limit CO emissions, as needed, with lower operating costs than techniques for limiting NOx emissions, such as SCR, AFCU, or AIG.

In view of the above, the concepts of the disclosure apply remote air addition or injection, instead of remote fuel injection. This technology is on the heater design level, instead of the burner level. The techniques are applicable with any burners that are designed for the fuel either with staged fuel or staged air feature, such as burners 20A, 20B described above. The technology is also applicable to raw gas burners, and other types of burners. The techniques described herein apply sub-stoichiometric combustion in the primary zone local to the burner 110 and diffused combustion or flameless combustion in the secondary lean combustion zone associated with the injection of remote air 118. Depending up on the fuel and heater operating conditions, the excess air can be controlled accordingly without negative impact on the NOx emissions.

With conventional burner arrangements, the peak flame temperature often leads to the maximum refractory surface temperature if the burners are fired against the refractory wall. The peak flame temperature and maximum refractory surface temperature may result in the maximum radiant coil metal temperature near the vicinity of the peak flame temperature, thus requiring more expensive metals with a higher TMT. The concepts of the disclosure provide options to lower the refractory surface temperature, which in turn lowers the maximum radiant coil metal temperature by introducing the remote combustion air 118 near the area with the potential maximum refractory surface temperature. The remote combustion air 118 will also lower the peak flame temperature when introduced into the radiant section 106.

This innovative firing arrangement not only reduces the NOx emission, but also provides options to adjust the heat flux distribution and radiant coil temperature profile. It is useful for heaters retrofit with air preheating and/or high H2 fuel. The NOx emission could be at or below the current emission levels without SCR or with a partial SCR. Thus, the implementations discussed herein enable an innovative firing arrangement that is capable of meeting NOx emission regulations while also achieving lower CO2 emissions and is suitable for retrofitting existing heaters or for new heater constructions.

In an implementation, a heater comprises: a radiant section; a burner located on a lower portion of the radiant section, the burner configured to receive a primary fuel stream and a primary combustion air stream through the burner to support a primary combustion reaction local to the burner; and a remote air pipe disposed on an upper portion of the radiant section distal from the burner and spaced from an envelope of the primary combustion reaction, the remote air pipe configured to inject a remote combustion air stream into the radiant section to support a secondary combustion reaction.

In an aspect, the remote air pipe is spaced from the burner by a distance of at least two meters.

In an aspect, the primary combustion air stream includes a majority of the total air introduced to the radiant section by the combination of the primary combustion air stream and the remote combustion air stream.

In an aspect, the primary fuel stream is all of the fuel introduced to the radiant section.

In an aspect, the remote air pipe is configured to only inject the remote combustion air stream into the radiant section.

In an aspect, the primary combustion reaction is sub-stoichiometric combustion that minimizes NOx formation and the secondary combustion reaction is lean combustion that further lowers NOx emissions concentration.

In an aspect, the primary fuel stream is high H2 fuel.

In an aspect, the remote air pipe extends vertically upward or vertically downward through the upper portion of the radiant section to provide preheating of the remote combustion air stream via heat duty from the radiant section.

In an aspect, the burner is a hearth burner, the heater further comprising a wall burner located at the upper portion of the radiant section and configured to burn any remaining hydrocarbons from the primary fuel stream following the primary combustion reaction and the secondary combustion reaction in a tertiary combustion reaction local to the wall burner.

In an aspect, the wall burner is located above the remote air pipe relative to the lower portion of the radiant section.

In an implementation, a heater comprises: a radiant section including a bottom wall and a side wall coupled to the bottom wall; a burner disposed on the bottom wall; a primary fuel stream and a primary combustion air stream configured to be provided through the burner to support a primary combustion reaction local to the burner at the bottom wall; a remote air pipe disposed on the side wall, the remote air pipe positioned at an elevation on the side wall that is at least two meters above the burner in a vertical direction; and a remote combustion air stream configured to be injected into the radiant section by the remote air pipe to support a secondary combustion reaction, wherein the primary combustion reaction is sub-stoichiometric combustion that minimizes NOx formation and the secondary combustion reaction is lean combustion that further lowers NOx emissions concentration.

In an aspect, the primary combustion air stream contains less air than needed to burn all of the hydrocarbon in the primary fuel stream, but more air than the remote combustion air stream.

In an aspect, unburned fuel from the primary fuel stream following the primary combustion reaction diffuses into the remote combustion air stream to support the lean combustion of the secondary combustion reaction.

In an aspect, the primary combustion air stream is preheated, or the primary fuel stream is high H2 fuel, or both.

In an aspect, the remote air pipe extends through the side wall of the radiant section without a substantial change in direction.

In an aspect, the remote air pipe extends upward or downward internal to the side wall of the radiant to preheat the remote combustion air stream via heat duty from the radiant section.

In an aspect, the burner is a first burner, the heater further comprising a second burner located on the side wall of the radiant section proximate the remote air pipe.

In an aspect, the second burner is a single row of wall burners configured to support a tertiary combustion reaction to burn any remaining hydrocarbon in the primary fuel stream following the primary combustion reaction and the secondary combustion reaction.

In an aspect, the second burner is located at a higher elevation on the side wall than the remote air pipe relative to the bottom wall.

In an aspect, the secondary combustion reaction is outside of an envelope of the primary combustion reaction.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied outside of the heater context, and are not limited to the example heater systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with heat recovery and heat exchanger devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims priority to U.S. Provisional Patent Application No. 63/514,248, filed Jul. 18, 2023, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A heater, comprising:
a radiant section;
a burner located on a lower portion of the radiant section, the burner configured to receive a primary fuel stream and a primary combustion air stream through the burner to support a primary combustion reaction local to the burner; and
a remote air pipe disposed on an upper portion of the radiant section distal from the burner and spaced from an envelope of the primary combustion reaction, the remote air pipe configured to inject a remote combustion air stream into the radiant section to support a secondary combustion reaction.

2. The heater of claim 1, wherein the remote air pipe is spaced from the burner by a distance of at least two meters.

3. The heater of claim 1, wherein the primary combustion air stream includes a majority of the total air introduced to the radiant section by the combination of the primary combustion air stream and the remote combustion air stream.

4. The heater of claim 1, wherein the primary fuel stream is all of the fuel introduced to the radiant section.

5. The heater of claim 1, wherein the remote air pipe is configured to only inject the remote combustion air stream into the radiant section.

6. The heater of claim 1, wherein the primary combustion reaction is sub-stoichiometric combustion that minimizes NOx formation and the secondary combustion reaction is lean combustion that further lowers NOx emissions concentration.

7. The heater of claim 1, wherein the primary fuel stream is high H2 fuel.

8. The heater of claim 1, wherein the remote air pipe extends vertically upward or vertically downward through the upper portion of the radiant section to provide preheating of the remote combustion air stream via heat duty from the radiant section.

9. The heater of claim 1, wherein the burner is a hearth burner, the heater further comprising:
a wall burner located at the upper portion of the radiant section and configured to burn any remaining hydrocarbons from the primary fuel stream following the primary combustion reaction and the secondary combustion reaction in a tertiary combustion reaction local to the wall burner.

10. The heater of claim 9, wherein the wall burner is located above the remote air pipe relative to the lower portion of the radiant section.

11. A heater, comprising:
a radiant section including a bottom wall and a side wall coupled to the bottom wall;
a burner disposed on the bottom wall;
a primary fuel stream and a primary combustion air stream configured to be provided through the burner to support a primary combustion reaction local to the burner at the bottom wall;
a remote air pipe disposed on the side wall, the remote air pipe positioned at an elevation on the side wall that is at least two meters above the burner in a vertical direction; and
a remote combustion air stream configured to be injected into the radiant section by the remote air pipe to support a secondary combustion reaction,
wherein the primary combustion reaction is sub-stoichiometric combustion that inhibits NOx formation and the secondary combustion reaction is lean combustion that further lowers NOx emissions concentration.

12. The heater of claim 11, wherein the primary combustion air stream contains less air than needed to burn all of the hydrocarbon in the primary fuel stream, and more air than the remote combustion air stream.

13. The heater of claim 11, wherein unburned fuel from the primary fuel stream following the primary combustion reaction diffuses into the remote combustion air stream to support the lean combustion of the secondary combustion reaction.

14. The heater of claim 11, wherein the primary combustion air stream is preheated, or the primary fuel stream is high H2 fuel, or both.

15. The heater of claim 11, wherein the remote air pipe extends through the side wall of the radiant section without a substantial change in direction.

16. The heater of claim 11, wherein the remote air pipe extends upward or downward internal to the side wall of the radiant section to preheat the remote combustion air stream via heat duty from the radiant section.

17. The heater of claim 11, wherein the burner is a first burner, the heater further comprising:
a second burner located on the side wall of the radiant section proximate the remote air pipe.

18. The heater of claim 17, wherein the second burner is a single row of wall burners configured to support a tertiary combustion reaction to burn any remaining hydrocarbon in the primary fuel stream following the primary combustion reaction and the secondary combustion reaction.

19. The heater of claim 17, wherein the second burner is located at a higher elevation on the side wall than the remote air pipe relative to the bottom wall.

20. The heater of claim 11, wherein the secondary combustion reaction is outside of an envelope of the primary combustion reaction.
